(19) United States
(12) Patent Application Publication
(10) Pub. No.: US 2003/0172520 A1
(43) Pub. Date: Sep. 18, 2003

(54) Adjusting the flying characteristics of heads in disk drives

(76) Inventors: Hain-Ling Liu, Northborough, MA (US); Gary Walker, Sherborn, MA (US); Michael Mallary, Sterling, MA (US); Pat Hearn, Acton, MA (US)

Correspondence Address: David M. Sigmond, Maxtor Corporation, 2452 Clover Basin Drive, Longmont, CO, 80503, US

(21) Appl. No.: 10/340,009

(22) Filed: Jan. 10, 2003

Related U.S. Application Data
(63) Continuation-in-part of application No. 10/012,063, filed on Nov. 13, 2001.

(51) Int. Cl. G11B 5/127

(52) U.S. Cl. 29/603.03; 29/603.09

(57) ABSTRACT

Methods are provided for adjusting flying characteristics of magnetic recording media, e.g., sealed disk drives. Adjustment may be made by changing at least one environmental condition within the drive enclosure of the disk drive prior to sealing. Alternatively, adjustment may be made by changing the speed of the disk drive, i.e., the speed at which the disk spins. Methods are also provided for error correction within sealed disk drives.

### CROSS-REFERENCE TO RELATED APPLICATIONS

This application is a continuation-in-part application of and claims priority to U.S. application Ser. No. 10/012,063, filed on Nov. 13, 2001, the full disclosure of which is incorporated by reference herein.

### TECHNICAL FIELD

This invention relates to adjusting the flying characteristics of heads in disk drives.

### BACKGROUND

Hard drive assemblies (HDAs), otherwise known as disk drives, are commonly used for mass storage of computer programs and data. Magnetic recording media (“disks”) are coated with a magnetic material. Data is stored (“written”) on a disk by magnetizing spots on the coating in one direction or the opposite direction, to correspond to binary bits. The amount of data stored on the disk is referred to as the areal density of the disk, measured as tracks per inch (TPI) in the radial direction and bits per inch (BPI) in the circumferential direction. As of this writing, disks having an areal density of greater than 35k TPI and 300k BPI are generally referred to as “high areal density” disks.

Referring to FIG. 1, the data is written and read by spinning the disk 10 while a magnetic head 12, mounted on a load beam 16, “flies” over the upper surface 18 of the disk. A transducer (not shown) in the head 12 reads and writes the data. The head (a hydrodynamic air bearing slider) flies as a result of a gliding action caused by compression of a layer of air that is dragged along by the spinning disk surface. The air layer is compressed between the upper surface 18 of the disk and the adjacent lower, air-bearing surface 20 of the head.

The head flies very close to the surface of the disk, without touching the disk surface. Referring again to FIG. 1, the distance H between the lower, air-bearing surface 20 of the head 12 and the upper surface 18 of disk 10 is referred to as the “flying height”. As the areal density of the data stored on the disk increases, the flying height must decrease in order to ensure accurate read/write by the transducer. To achieve high areal densities, flying heights are typically on the order of 20 nanometers (nm) or less. If the flying height is too small, however, contact with the disk surface becomes more likely, particularly if the disk topography is not perfectly flat. This contact may result in damage to the disk and/or the head.

Thus, it is very important that the flying height be carefully controlled, and, for a given type of disk drive, that the variability of the flying height from one individual disk drive to another be very small. Lowering flying height to increase data density has increased the risk that variability in flying heights between individual disk drives will cause loss of read/write performance and/or damage to the head or disk due to contact between the head and disk. Despite efforts to control flying height, the variability in flying height between individual disk drives tends to be relatively high, due to the cumulative effect of the manufacturing tolerances of each of the many parts used in a disk drive. There also tends to be variability between the flying heights of individual heads within a multiple-head disk drive.

In addition to flying height, there are other flying characteristics of the head that should generally be controlled to optimize read/write accuracy and avoid head or disk damage. These characteristics include the pitch angle and roll angle of the head.

### SUMMARY

The invention features methods of adjusting flying characteristics of a head in a sealed disk drive. These methods have been found to significantly reduce the variation in flying characteristics of a group of individual disk drives of the same type, i.e., the standard deviation or “sigma” in flying characteristics that results from the stack-up of manufacturing tolerances of the assembled parts of the disk drives within the group. In some implementations, the sigma is reduced to the level of measurement error of the tests that determine flying characteristics. Reducing the variation between disk drives in a group results in a more consistent product, and generally enhances the mechanical and electrical performance and the reliability of the sealed disk drives.

In one aspect, the invention features a method of adjusting a flying characteristic of a head within a sealed disk drive enclosure. The method includes: (a) providing an unsealed disk drive enclosure containing a head, the atmosphere within the disk drive enclosure having certain properties; (b) testing a flying characteristic of the head; (c) determining whether the flying characteristic is within a predetermined range of values; (d) if the flying characteristic is not within the range, changing a property of the atmosphere sufficiently to bring the flying characteristic within the range; and (e) sealing the disk drive enclosure.

Some implementations may include one or more of the following features. The flying characteristic includes the flying height of the head. The testing step includes writing a predetermined pattern on the disk surface, sending a readback signal by reading back the predetermined pattern, identifying sample values corresponding to the readback signal, and calculating a change in the flying height by utilizing the sample values. The property that is changed is selected from the group consisting of ambient pressure, ambient temperature, composition, mean free path and viscosity of a gas within the enclosure. The changing step includes changing more than one of the properties of the atmosphere. The testing is performed in an operational disk drive assembly.

In another aspect, the invention features a method of reducing variation between members of a group of sealed disk drives of the same type, each disk drive including an enclosure, the atmosphere within the disk drive enclosure having certain properties, and a head within the enclosure. The method includes, for each disk drive: (a) testing a flying characteristic of the head; (b) determining whether the flying characteristic is within a predetermined range of values; (c) if the flying characteristic is not within the range, changing a property of the atmosphere sufficiently to bring the flying characteristic within the range; and (d) sealing the disk drive enclosure.

Some implementations may include one or more of the following features. Each disk drive includes multiple heads. The testing step has a predetermined level of measurement error, and the method further comprises selecting the predetermined range to be no greater than the level of measurement error. The method further includes selecting the predetermined range so as to reduce the variation in the flying characteristic between the disk drives by at least 10%, preferably so as to reduce the variation in the flying characteristic by at least 25%. The flying characteristic includes flying height, pitch angle and/or roll angle. The property that is changed is selected from the group consisting of ambient pressure, ambient temperature, composition, mean free path and viscosity of a gas within the enclosure. The changing step includes changing more than one of the properties of the atmosphere. The testing is performed within the enclosure.

In another aspect, the invention features a method of adjusting a flying characteristic of a head within a sealed disk drive enclosure that includes: (a) providing a disk drive enclosure containing a head; (b) testing a flying characteristic of the head while the disk drive is operating at a predetermined speed; (c) determining whether the flying characteristic is within a predetermined range of values; and (d) if the flying characteristic is not within the range, adjusting the speed of the disk drive sufficiently to bring the flying characteristic within the range. The disk drive may include a single head or multiple heads. By the “speed of the disk drive” we mean the speed at which a disk is rotated by a motor within the disk drive.

The invention also features a method of error correction within a sealed disk drive. The method includes (a) providing a sealed disk drive containing a head that flies at a predetermined flying height when the disk drive is in use; (b) monitoring a characteristic of the disk drive when the disk drive is in operating at a predetermined speed; and (c) adjusting the speed of the disk drive in response to changes in the characteristic. The characteristic may be, e.g., the flying height, the pressure within the sealed disk drive, or the read/write performance of the disk drive.

The term “flying height”, when used without a modifier (mean, gap, minimum or maximum), refers to gap flying height.

Other features and advantages of the invention will be apparent from the following detailed description and drawings of an embodiment of the invention, and from the claims.

### DESCRIPTION OF DRAWINGS

FIG. 1 is a diagrammatic side view of a sealed disk drive containing a disk and a magnetic head.

FIG. 2 is a flowchart showing steps in a procedure described below.

FIGS. 3-3C are graphs showing the effect of changing mean free path on various flying characteristics.

FIGS. 4-4C are graphs showing the effect of changing ambient pressure (expressed as altitude) on various flying characteristics.

FIG. 5 is a graph showing the change in flying height distribution in a two-head disk drive, resulting from flying height adjustment using a procedure described below.

FIG. 6 is a graph showing the relationship of mean free path to gas composition.

FIGS. 7 and 8 are flowcharts showing steps in alternative procedures described below.

FIGS. 9 and 10 are graphs showing, respectively, calculated flying height as a function of disk velocity at constant pressure, and calculated flying height as a function of pressure (altitude) at a constant velocity.

### DETAILED DESCRIPTION

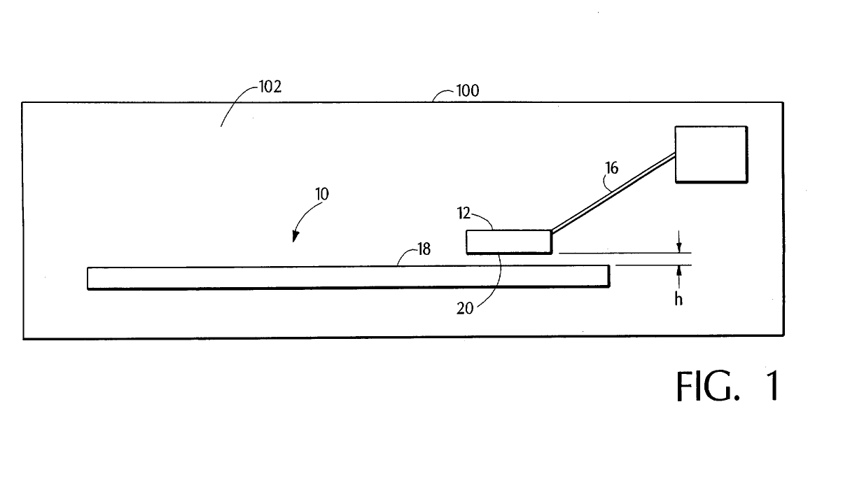

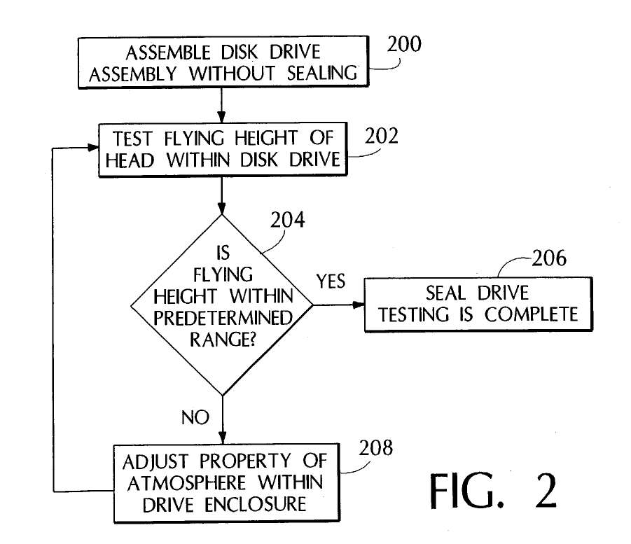

Referring to FIG. 1, a sealed disk drive 100 includes a magnetic head 12, mounted on a load beam 16. As explained above, head 12 flies over the upper surface 18 of a spinning disk 10 while a transducer (not shown) in the head 12 reads and/or writes data on the disk. A sealed enclosure 102 surrounds the head, load beam and disk, and contains an atmosphere 104. As discussed above in the Background, the head (a hydrodynamic air bearing slider or “ABS”) flies as a result of a gliding action caused by compression of a layer of air that is dragged along by the spinning disk surface and compressed between the upper surface 18 of the disk and the adjacent lower, air-bearing surface 20 of the head. The distance H between the lower, air-bearing surface 20 of the head 12 and the upper surface 18 of disk 10 is referred to as the “flying height”.

As will be discussed in detail below, the flying height and other flying characteristics of head 12 in sealed disk drive 100 may be adjusted by changing one or more of the properties of the atmosphere 104 within the drive enclosure prior to sealing. Properties that may be changed include the composition, ambient pressure, ambient temperature, mean free path and/or viscosity of the gas that constitutes the atmosphere. When temperature is used, generally the operating temperature of the drive should be taken into account.

Steps in a method of adjusting flying height are shown in FIG. 2. These steps would generally be performed on each individual disk drive in a set of identical disk drives. Prior to performing these steps (in some cases when the disk drive is first designed or prototyped), a predetermined range is selected within which the flying height of each individual disk drive should fall before the disk drive is sealed and shipped. The predetermined range may be specified in terms of the maximum, minimum, and/or average gap flying height, as will be discussed in detail below.

As shown in FIG. 2, the disk drive is first assembled, without sealing it (200). Next, the flying height of the head (or each head, if the drive includes multiple heads) is measured (202). Preferably, measurement is performed “in situ,” i.e., within an operating disk drive assembly. Suitable test methods include those described in U.S. Pat. No. 5,168,413, or in U.S. Pat. No. 4,777,544, the complete disclosures of which are incorporated herein by reference. As described in U.S. Pat. No. 5,168,413, testing may include writing a predetermined pattern on the disk surface, sending a readback signal by reading back the predetermined pattern, identifying sample values corresponding to the readback signal, and calculating a change in the flying height by utilizing the sample values.

This testing will determine whether the disk drive, as assembled, has a head flying height that is within the predetermined range (204). If the flying height of the head is already within the range, the drive can be sealed and is ready for further quality control or for final shipment (206).

If, however, the flying height is not within the predetermined range, an incremental change is made to a property of the atmosphere within the drive enclosure (208). Examples of suitable changes are discussed in detail below. The parameter(s) to be adjusted can be selected manually, by an operator, or automatically. The flying height may be adjusted using one of the procedures described in detail in the examples below, or using any desired procedure. Preferably, the adjustment is performed immediately prior to sealing of the drive, e.g., within a few seconds of sealing.

Next, the flying height is tested again (202) to determine whether the adjustment has brought it within the predetermined range. If not, further adjustment and testing is performed, as indicated by the loop in FIG. 2. This iterative process is continued until the flying height is within the predetermined range. Adjustment and testing may be performed manually, by an operator, or automatically, using a feedback control process. When the flying height is within the predetermined range, the disk drive is sealed and the adjustment procedure is complete.

This procedure is repeated for each of the disk drives in a production run.

To allow the disk drive to be sealed without compromising the adjusted gas conditions within the disk drive, it is generally preferred that the disk drive be almost completely sealed (e.g., at least about 90% sealed, preferably about 99% sealed) prior to adjustment. A small tube may be provided, through which the gas conditions can be adjusted. This allows the unsealed area (the bore of the tube) to be easily and quickly sealed when adjustment has been completed.

Flying height may be measured, and thus the predetermined range may be specified, in a number of different ways. “Maximum gap flying height” measures the largest distance between the read/write (r/w) gap on the air-bearing surface of the head and the surface of the disk over which the head is flying. “Minimum gap flying height” measures the smallest distance between the r/w gap on the air-bearing surface of the head and the surface of the disk over which the head is flying. “Average gap flying height” measures the average r/w gap spacing between the transducer and the disk surface. While there are some minor differences in testing, mean gap flying height is approximately equivalent to average gap flying height when a relatively large number of units is tested. Criteria for quality control can be one or a combination of these values, or other types of flying height measurements.

Different approaches to adjusting flying height can be used in the methods described above, to achieve a number of different objectives. For example, the flying heights can be adjusted so that the mean flying height of each of the heads is at, or within a predetermined range of, the design level. Alternatively, or in addition, the flying heights can be adjusted so that the maximum and/or minimum flying height of each of the heads in each of the disk drives is within a predetermined range. Adjusting the mean flying height will bring the drive closer to design performance criteria, while adjusting the maximum flying height will enhance read/write performance and adjusting the minimum flying height will improve tribological reliability.

For single head disk drives, the variation in head flying height from drive to drive (the “flying height sigma”) can generally be reduced to the level of measurement error that is inherent in the flying height test. For multiple head drives, it may not be possible to reduce the flying height sigma as much, because when the gas conditions are adjusted the flying heights of all of the heads will be adjusted to the same extent. Thus, for example, if some of the heads have flying heights that are excessively high, and other heads have flying heights that are at the low end of the acceptable range, there is a limit to the extent that the high flying heights can be reduced, as this reduction will make the low flying heads fly even lower.

The rate of flying height change as a function of change in the gas characteristics of the environment is dependent to some extent on the design of the air-bearing surface (ABS) of the head. Thus, the change required to obtain a particular amount of adjustment may be different for different ABS designs, and certain designs may be more suitable for use in the adjustment techniques described herein.

The following is a discussion of properties that may be changed to adjust flying height, and the relationships between these properties.

Flying height is determined by the mean free path and viscosity of the gas within the enclosure. Decreasing the gas mean free path will generally result in an increase in flying height. Decreasing viscosity will generally result in a decrease in flying height.

The mean free path and viscosity can be changed by changing the gas composition that is delivered to the drive enclosure prior to sealing. For a helium/air atmosphere, the gas mean free path and gas viscosity will vary as a function of the air/helium ratio (see, e.g., T. Ohkubo et al., “Static Characteristics of Gas-Lubricated Slider Bearings Operating in a Helium-Air Mixture,” Journal of Tribology, Vol. 111, pp. 620-627, 1989). Increasing the relative amount of air in the mixture will decrease the overall gas mean free path of the atmosphere, and decrease the viscosity of the gas, resulting in an increase in the flying height of the head. Decrease in the viscosity of the gas is generally not monotonic (id., FIG. 2).

Alternatively, the mean free path and viscosity can be changed by changing the ambient pressure and/or ambient temperature of the atmosphere within the drive enclosure. Gas mean free path (λ) is directly proportional to ambient temperature over ambient pressure (λ˜T/P). Gas viscosity (η) is directly proportional to the ambient temperature to the one-half power (η˜T^{1/2}). Thus, decreasing the temperature will generally decrease the mean free path and thereby increase the flying height. Because mean free path is inversely proportional to pressure, decreasing the pressure at a constant temperature will decrease the flying height.

### EXAMPLE 1

A simulation was performed, using as criteria a single-head disk drive, having a head with an ABS that is commercially available from ALPS under the tradename Phantom. The simulation was used to investigate the effect of changing the mean free path and ambient pressure of the gas within the drive enclosure. Simulation was used to obtain the gap flying heights and minimum flying heights of the heads in each of the disk drives.

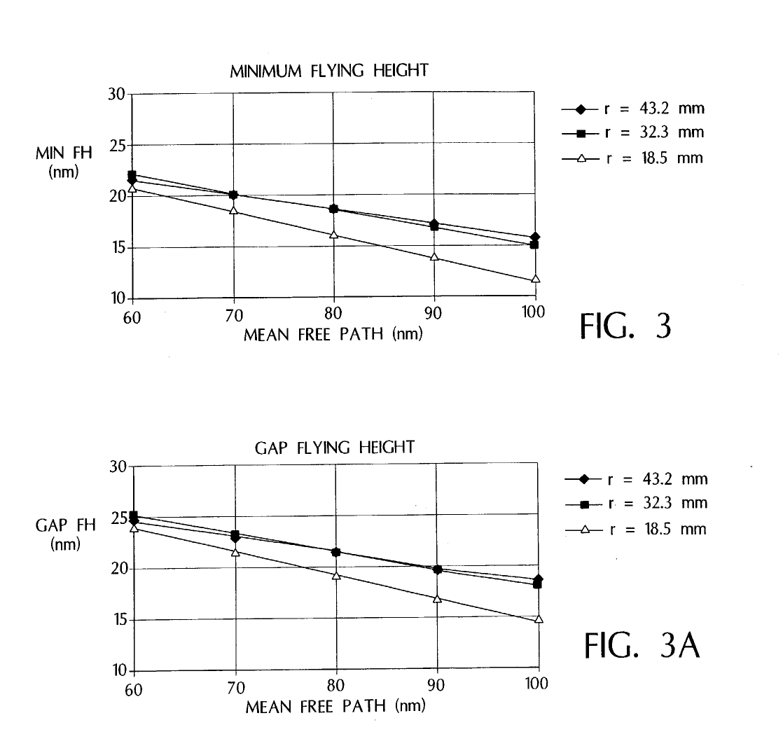

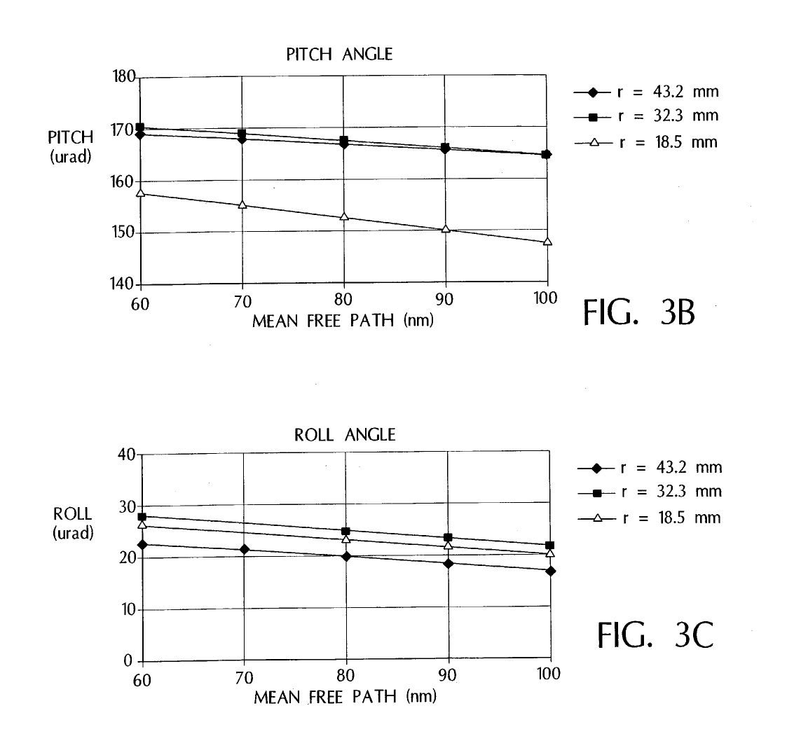

After each of a series of incremental (10 nm) changes in the gas mean free path, the minimum flying heights and gap flying heights were determined mathematically. The results are shown graphically in FIGS. 3 and 3A. As shown in FIGS. 3 and 3A, the minimum flying height and gap flying height were both significantly reduced by adjusting the gas mean free path upward from 60 to 100 nm.

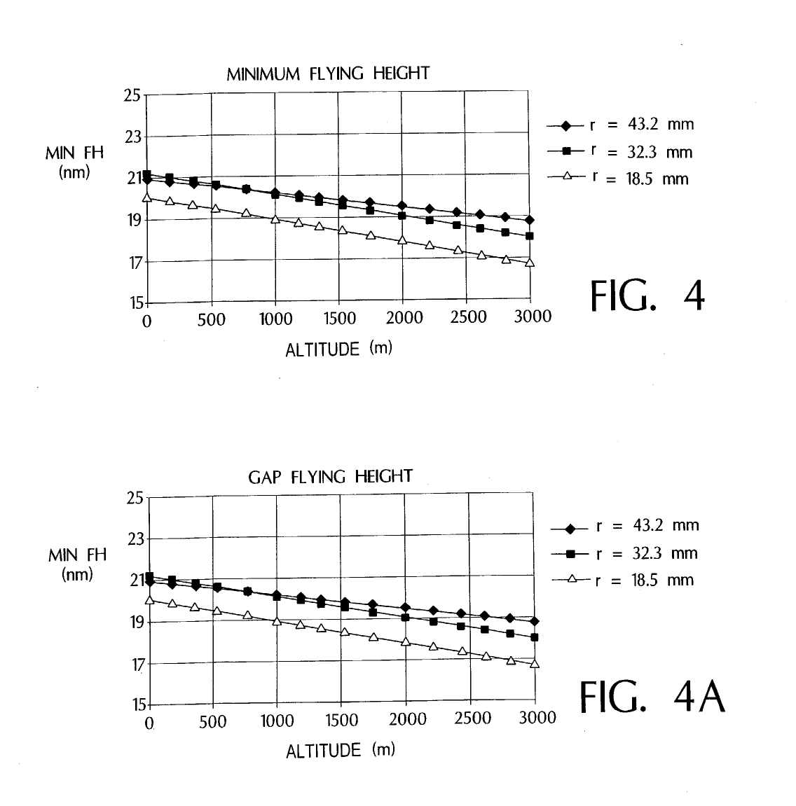

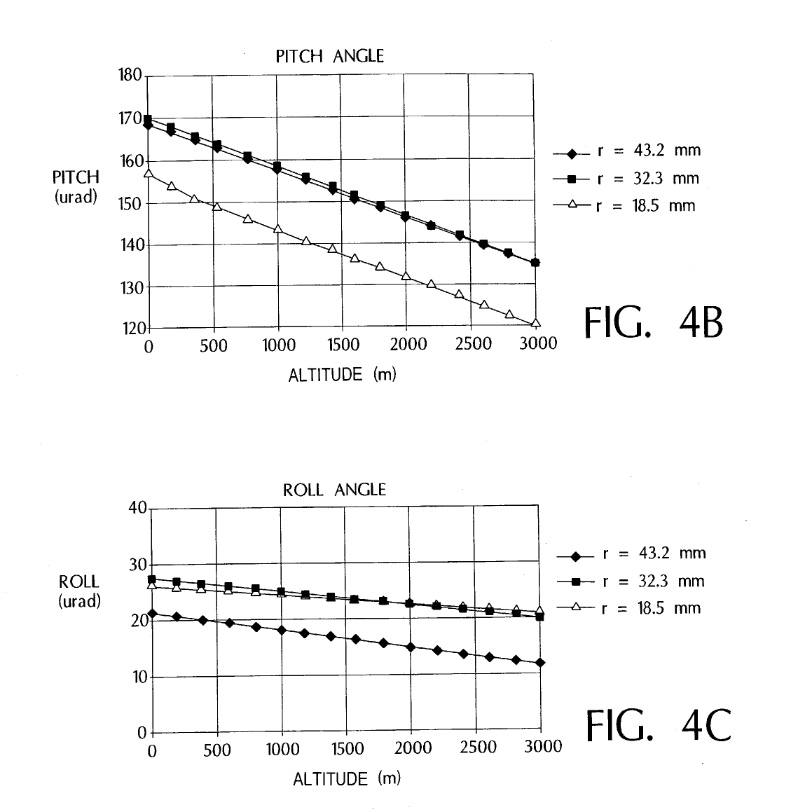

The ambient pressure (expressed as altitude in FIGS. 4-4A) was also adjusted by simulation. After each of a series of incremental (200 m) changes in the pressure, the minimum flying heights and gap flying heights were determined. The results are shown graphically in FIGS. 4 and 4A. FIGS. 4 and 4A show that the minimum and gap flying heights were also significantly reduced by raising the ambient pressure within the drive enclosure.

The sensitivity of the ABS to mean free path and pressure is different at different disk radii, and thus three different radii were studied (“r” in FIGS. 3-3C and 4-4C signifies disk radius).

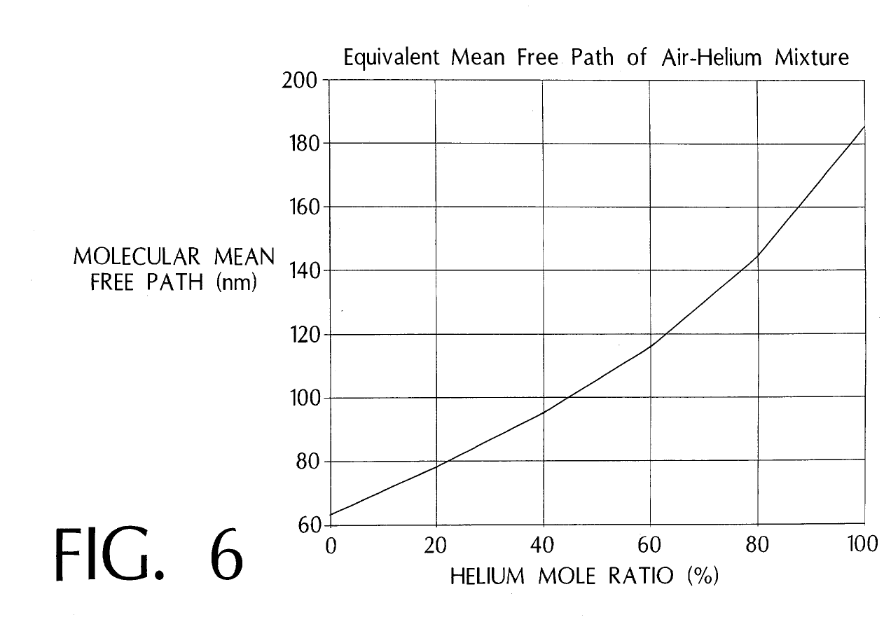

It is believed that the data obtained by simulation will correlate well with experimental data. The change in flying height that would be obtained by using a given Helium/air ratio can be predicted, using the data obtained by a simulation such as that described above, be referring to a graph that gives the relationship between mean free path and Helium/air ratio (FIG. 6).

### EXAMPLE 2

Another simulation was conducted to determine the change in flying height sigma (standard deviation) that could be obtained by an optimal adjustment of flying height in a two head drive. A random number generator was used with an assumed flying height sigma (based on a sigma that was determined empirically in another experiment) to generate flying heights for the heads in a hypothetical group of 10,000 two-head drives. The flying heights were then adjusted so that the average of the average gap flying heights of the two heads in each drive was equal to the design flying height for the drive design (16.5 nm in this case). In this simulation, it was assumed that such an adjustment would be possible, based on the results of the simulation described in Example 1.

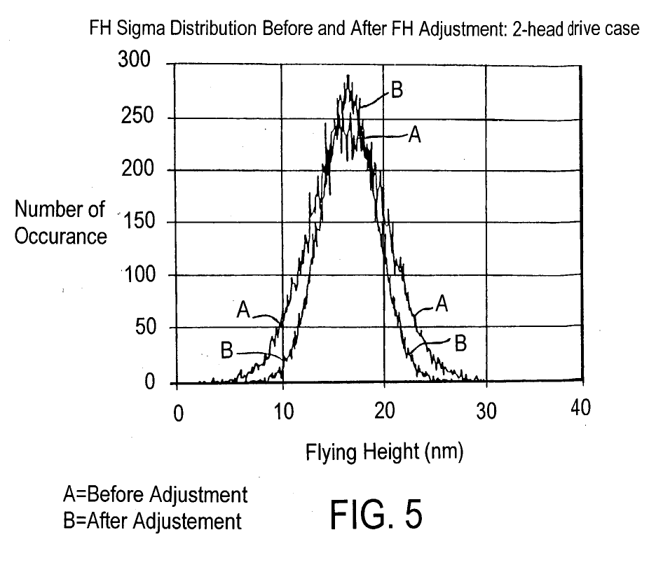

The flying height distribution of the group of drives before adjustment and the flying height distribution after adjustment are shown in FIG. 5. The results of this mathematical model indicate that a significant reduction (about 30%) in flying height sigma is obtained as a result of adjusting the flying height in the manner described above.

Other embodiments are within the scope of the following claims. For example, the methods described above can also be used to adjust other flying characteristics, such as the pitch angle and roll angle of the head.

The pitch angle and roll angle were simulated as described in Example 1 above. The pitch angle and roll angle as a function of mean free path of the gas within the first disk drive are shown in FIGS. 3B and 3C, respectively. These figures indicated that the pitch angle and roll angle of the head were adjusted as a result of a change in the mean free path. The pitch angle and roll angle as a function of the pressure of the gas within the second disk drive are shown in FIGS. 4B and 4C, respectively. These figures indicated that the pitch angle and roll angle of the head were adjusted as a result of a change in the pressure.

While helium and air are mentioned as suitable gases above, other gases and mixtures of gases can be used to adjust mean free path. The mean free paths of the gases used can be used to predict the final mean free path of the environment in the drive. Suitable gases include hydrogen (H₂; mean free path 117 nm), nitrogen (N₂; mean free path 62.8 nm) and carbon dioxide (mean free path 41.9 nm).

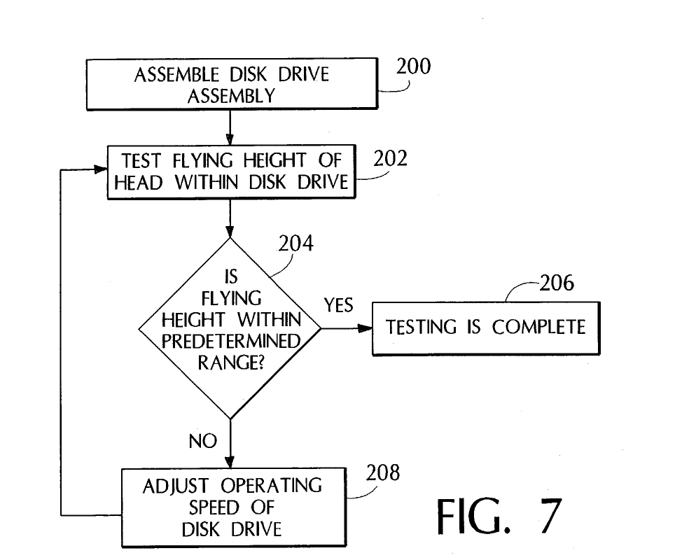

In addition, the flying height may be adjusted using other techniques. For example, as shown in FIG. 7, the flying height may be adjusted by adjusting the speed of the disk drive (308), i.e., the speed at which a disk is rotated by a motor in the disk drive.

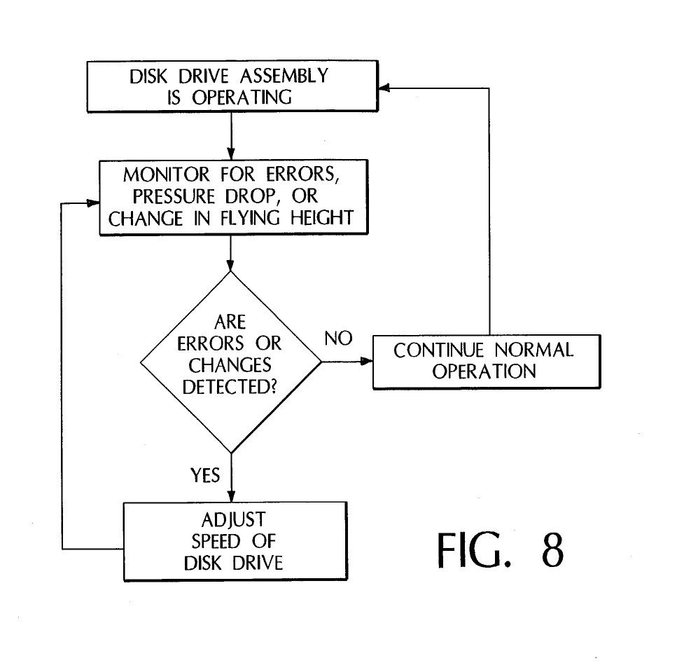

Adjustments to the drive speed may also be used to provide error recovery when leakage occurs in sealed disk drives, e.g., as shown in FIG. 8. Because leakage will result in a change in the ambient pressure within the drive, if sufficient leakage occurs the flying height of the head(s) within the drive my change sufficiently to cause errors or even loss of data. To counteract such changes in flying height, the disk drive may be configured to measure flying height and to automatically adjust drive speed when a change in flying height is detected. Speed would be adjusted sufficiently to return the head(s) to within a given tolerance of the previous flying height(s). Alternatively, rather than measuring flying height, the disk drive may be configured to measure pressure within the drive, or to examine data to detect errors, e.g., using a position error signal on the head or by looking for Wallace Spacing Loss (comparing the ratio of the amplitudes of low and high frequency data to a predetermined ratio), and to adjust the drive speed accordingly.

If the drive speed is lowered to adjust flying height, it may be necessary to modify the electronics of the disk drive to allow the drive to function at a lower speed. One option is a disk-locked clock, which will allow the drive to function at an arbitrary speed.

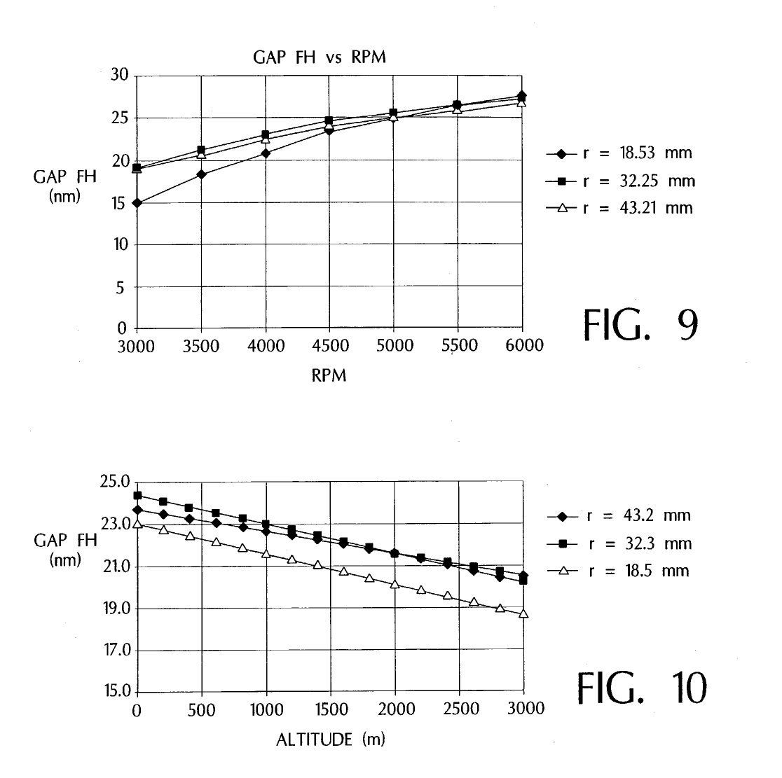

FIGS. 9 and 10 illustrate an example of a low pressure sealed drive in which the nominal pressure is equivalent to 300 meters of altitude above sea level and the disk rotational velocity is 4500 RPM. FIG. 9 shows the calculated fly height vs disk velocity in air at atmospheric pressure. FIG. 10 shows the fly height vs pressure reduction (altitude) at a constant velocity of 4500 rpm. At a radius of 32.3 mm, FIG. 10 shows that the head would fly at 20.3 nm. If the seal of this drive leaked so that the pressure rose to one atmosphere at sea level, the fly height at this radius would increase to 24.5 nm. For a linear data density of half a million bits per inch, this would result in a 23% reduction in read back amplitude according to the well known Wallace spacing loss formula. This amount of high frequency amplitude loss would result in a high likelihood of read back errors. According to the present invention, this problem may be overcome, long enough to recover the data, by reducing the rotational velocity to 3300 rpm. FIG. 9 shows that this reduction in RPM will reestablish the design fly height of 20.3 nm and thus allow the drive to continue to function properly. Thus, the data could be transferred to a back up storage devise without any loss of integrity.

What is claimed is:

1. A method of adjusting a flying characteristic of a head within a sealed disk drive enclosure, comprising,
providing a disk drive enclosure containing a head, the atmosphere within the disk drive enclosure having certain properties, the enclosure being at least partially unsealed;
testing a flying characteristic of the head;
determining whether the flying characteristic is within a predetermined range of values;
if the flying characteristic is not within the range, changing a property of the atmosphere sufficiently to bring the flying characteristic within the range; and
sealing the disk drive enclosure.

2. The method of claim 1 wherein the flying characteristic comprises the flying height of the head.

3. The method of claim 1 further comprising sealing the disk drive at least about 90% prior to changing the property of the atmosphere.

4. The method of claim 3wherein the disk drive is sealed at least about 99% prior to changing the property of the atmosphere.

5. The method of claim 1 further comprising repeating the testing, determining and changing steps as an iterative process until the flying characteristic is within the predetermined range of values.

6. The method of claim 5 wherein the iterative process is performed using automatic feedback control.

7. The method of claim 1 wherein the testing step comprises writing a predetermined pattern on the disk surface, sending a readback signal by reading back the predetermined pattern, identifying sample values corresponding to the readback signal, and calculating a change in the flying height by utilizing the sample values.

8. The method of claim 1 wherein the property that is changed is selected from the group consisting of ambient pressure, ambient temperature, composition, mean free path and viscosity of a gas within the enclosure.

9. The method of claim 1 wherein the changing step comprises changing more than one of the properties of the atmosphere.

10. The method of claim 2 wherein the testing is performed in an operational disk drive assembly.

11. The method of claim 2 wherein the flying height is measured as mean gap flying height.

12. The method of claim 2 wherein the flying height is measured as maximum gap flying height.

13. The method of claim 2 wherein the flying height is measured as minimum gap flying height.

14. The method of claim 1 wherein the changing step comprises changing the ratio of two or more gases within the enclosure.

15. The method of claim 14 wherein the changing step comprises changing the ratio of helium to air within the enclosure.

16. A method of reducing variation between members of a group of sealed disk drives of the same type, each disk drive including an enclosure, the atmosphere within the disk drive enclosure having certain properties, and a head within the enclosure, the method comprising, for each disk drive:
testing a flying characteristic of the head;
determining whether the flying characteristic is within a predetermined range of values;
if the flying characteristic is not within the range, changing a property of the atmosphere sufficiently to bring the flying characteristic within the range; and
sealing the disk drive enclosure.

17. The method of claim 16 wherein each disk drive includes multiple heads.

18. The method of claim 16 wherein the testing step has a predetermined level of measurement error, and the method further comprises selecting the predetermined range to be no greater than the level of measurement error.

19. The method of claim 16 comprising selecting the predetermined range so as to reduce the variation in the flying characteristic between the disk drives by at least 10%.

20. The method of claim 19 comprising selecting the predetermined range so as to reduce the variation in the flying characteristic by at least 25%.

21. The method of claim 16 wherein the flying characteristic comprises flying height.

22. The method of claim 16 wherein the property that is changed is selected from the group consisting of ambient pressure, ambient temperature, composition, mean free path and viscosity of a gas within the enclosure.

23. The method of claim 16 wherein the changing step comprises changing more than one of the properties of the atmosphere.

24. The method of claim 16 wherein the changing step comprises changing the ratio of two or more gases within the enclosure.

25. The method of claim 24 wherein the changing step comprises changing the ratio of helium to air within the enclosure.

26. The method of claim 16 wherein the testing step is performed within the enclosure.

27. A method of adjusting a flying characteristic of a head within a sealed disk drive enclosure, comprising,
providing a disk drive enclosure containing a head, the atmosphere within the disk drive enclosure having certain properties, the enclosure being at least 90% sealed and including an opening through which a gas can be introduced to the enclosure;
testing a flying characteristic of the head;
determining whether the flying characteristic is within a predetermined range of values;
if the flying characteristic is not within the range, changing a property of the atmosphere sufficiently to bring the flying characteristic within the range; and
sealing the opening to completely seal the disk drive enclosure.

28. A method of adjusting a flying characteristic of a head within a sealed disk drive enclosure comprising:
(a) providing a disk drive enclosure containing a head;
(b) testing a flying characteristic of the head while the disk drive is operating at a predetermined speed;
(c) determining whether the flying characteristic is within a predetermined range of values; and
(d) if the flying characteristic is not within the range, adjusting the speed of the disk drive sufficiently to bring the flying characteristic within the range.

29. The method of claim 28 wherein the disk drive includes multiple heads.

30. A method of error correction within a sealed disk drive, comprising:
(a) providing a sealed disk drive containing a head that flies at a predetermined flying height when the disk drive is operating at a predetermined speed;
(b) monitoring a characteristic of the disk drive when the disk drive is in use; and
(c) adjusting the speed of the disk drive in response to changes in the characteristic.

31. The method of claim 30 wherein the characteristic is selected from the group consisting of the flying height, the pressure within the sealed disk drive, and the read/write performance of the disk drive.
